(19) United States
(12) Patent Application Publication
(10) Pub. No.: US 2004/0230582 A1
(43) Pub. Date: Nov. 18, 2004

(54) Arrangement, storage medium and method for providing information which is obtained via a device type manager, and transmitted in an extensible mark-up language format or a hypertext mark-up language format

(76) Inventors: Marco Aurelio de Oliveira Pagnano, Sertaozinho (BR); Luis Gustavo de Carvalhc Bechuate, Sertaozinho (BR)

Correspondence Address: BAKER & BOTTS, 30 ROCKEFELLER PLAZA, NEW YORK, NY, 10112

(21) Appl. No.: 10/436,955

(22) Filed: May 13, 2003

(51) Int. Cl. G06F 7/00

(52) U.S. Cl. 707/100

(57) ABSTRACT

An information arrangement, storage medium and a method for providing information in a process using such arrangement, are provided. Specifically, a first processing system is communicatively coupled to a second processing system, and the second processing system is communicatively coupled to one or more field devices. The second processing system includes a Device Type Manager (“DTM”), and the DTM includes properties associated with the field device. Moreover, the first processing system is adapted to receive data associated with the properties from the second processing system, and to transmit the data associated with the properties in an Extensible Mark-up Language (“XML”) format or a Hypertext Mark-up Language (“HTML”) format.

### FIELD OF THE INVENTION

The present invention relates generally to an arrangement, storage medium and method which provide information in an Extensible Mark-up Language (“XML”) format or a Hypertext Mark-up Language (“HTML”) format. In particular, the invention is directed towards the arrangement, storage medium and method in which information associated with a field device is obtained via a Device Type Manager, converted into the XML format or the HTML format, and is transmitted to another device in the XML format or the HTML format.

### BACKGROUND OF THE INVENTION

Conventional information arrangements can include a plurality of field devices (e.g., smart field devices) that are positioned at various locations on a network. These smart field devices generally include a processor, and can be temperature sensors, pressure sensors, flow rate sensors, valves, switches, etc., or combinations thereof. The smart field devices are communicatively coupled to each other using an open smart communications protocol. Such open smart communications protocols may include HART®, PROFIBUS®, FOUNDATION® Fieldbus, etc. Such open smart communications protocols enable smart field devices that are manufactured by different manufactures to be used together in the same process. The conventional arrangements can also include a controller communicatively coupled to each of the smart field devices using the open smart communications protocol. Moreover, the controller may include a processor, and can receive data from each of the smart field devices.

In operation, each of the smart field devices generally performs a function within the arrangement. For example, a temperature sensor measures a temperature of a liquid, a pressure sensor measures pressure within a container, a flow rate sensor measures a flow rate of the liquid, etc. Similarly, valves and switches can open to allow or increase the flow of the liquid, or may close to stop the flow of the liquid or to decrease the flow rate of the liquid. After the smart field devices obtain measurements of various process parameters, or the valves or switches are opened/closed, the smart field devices can communicate with the controller. Specifically, the smart field devices forward the data to the controller, and the controller forwards the data to a server.

Moreover, the server includes a plurality of Device Type Managers (DTMs), and each of the DTMs may be associated with one or more of the smart field devices. Each of the DTMs is a software plugin which can preferably be provided by a manufacturer of each smart field device. The DTM is a software plugin that includes a user interface portion and a business portion. The business portion includes the data associated with the one or more properties (e.g., parameters, options, configurations, diagnosis, maintenance, etc.), and the user interface portion is adapted to display the data associated with the one or more properties (e.g., graphical user dialogs). The user interface portion and the business portion are ActiveX® software programs. Further, all of the operations associated with the smart field device are executed by the DTM.

If a user of remote host computer system wants to view the properties associated with the smart field devices and/or the measurements obtained by the smart field devices, it has to download the interface component, and the interface component accesses the business component. As such, the interface component allows the user of the remote host computer system to view the properties associated with the smart field devices and/or the measurements obtained by the smart field devices. Nevertheless, when the remote host computer system downloads the interface portion, this remote host computer system may be exposed to components which the remote host computer system interprets as being ActiveX® components (“fake ActiveX® components”), and the “fake ActiveX® components” have access to the remote host computer system. As such, the “fake ActiveX® components” have access to proprietary information of the remote host computer system. Moreover, when the remote host computer system is a slower or older computer system, downloading such software may take more time than desired or acceptable.

### SUMMARY OF THE INVENTION

Therefore, a need has arisen to provide arrangements and methods which overcome the above-described and other shortcomings of the prior art. One of the advantages of the present invention is that a pure hypertext mark-up language (“HTML”) page or a pure Extensible Mark-up Language (“XML”) page (which includes the properties associated with the smart field devices and/or the measurements obtained by the smart field devices) that can be stylized by a XML Stylesheet Language page, can be transmitted to a remote processing system. Consequently, the properties associated with the smart field devices and/or the measurements obtained by the smart field devices may be transferred to a server of a host processing system and may be displayed to a user of the remote processing system using any browser, without downloading additional software. Another advantage of the present invention is that the remote processing system does not allow ActiveX® components to access proprietary information of the remote processing system.

According to an exemplary embodiment of the present invention, an information arrangement, storage medium and method for providing information for a process, are provided. Specifically, a first processing system (e.g., a first server) may be communicatively coupled to a second processing system (e.g., a second server), and the second processing system can be communicatively coupled to one or more field devices (e.g., a temperature sensor, pressure sensor, flow rate sensor, valve, switch, etc.), e.g., via a controller. For example, the controller can be communicatively coupled to the field device by an open smart communications protocol (e.g., a PROFIBUS protocol, a FOUNDATIONS® Fieldbus protocol, a HART® protocol, etc.).

Moreover, the second processing system may include a Device Type Manager (“DTM”), and the DTM can have one or more properties (e.g., parameters, options, configurations, diagnosis, maintenance, graphical user dialogs, etc.) associated with the field device. The first processing system may be adapted to receive data associated with such properties from the second processing system, and to convert the data associated with the properties into a Hypertext Mark-up Language (“HTML”) format or an Extensible Mark-up Language (“XML”) format that can be stylized by a XML Stylesheet Language. The first processing system can then transmit the converted data to a remote processing system, such as a personal computer, palm pilot, cellular phone, etc. For example, the data associated with these properties can be a particular value associated with one more of the parameters. Moreover, the particular value can be associated with a measurement performed by the field device (e.g., temperature measurement, pressure measurement, flow-rate measurement, etc.).

In another exemplary embodiment of the present invention, the DTM can be a software plugin that includes a user interface portion and a business portion, and the first processing system may include an active server page script. The business portion may include the data associated with the one or more properties. The business portion also may include an interface which transfers the data that represents the user interface portion (e.g., graphical user dialogs) in the XML format that can be stylized by the XML Stylesheet Language. The user interface portion may be adapted to display the data associated with such one or more properties. The second processing system can further include one or more user applications. For example, such one or more user applications can include a Field Device Tool (FDT), and the FDT can include an inquiry portion which reads the data that represents the interface portion and the data associated with the one or more properties. Further, the active server page script may be adapted to access the inquiry portion. The inquiry portion can be adapted to access the data associated with the one or more properties, and to transmit this data to the first processing system. Moreover, when the first processing system receives the data from the inquiry portion, the active server page script can be adapted to create an XML or a HTML page including the data, and to transmit the XML page or the HTML page (e.g., to the remote processing system, such as a remote client processing system) using the Internet. For example, the XML page or the HTML page may be a Web-type page, window-type page, spreadsheet-type page, etc.

According to yet another exemplary embodiment of the present invention, an arrangement and method for providing information for a process are provided. Specifically, a processing system of the arrangement may be communicatively coupled to one or more field devices. The processing system may include the DTM, and such DTM can include one or more properties associated with the field device. The processing system may be adapted to transmit the data associated with the properties in the (XML) HTML format, e.g., to a host processing system, such as a personal computer, palm pilot, cellular phone, etc.

### BRIEF DESCRIPTION OF THE DRAWINGS

For a more complete understanding of the present invention, the needs satisfied thereby, and the objects, features, and advantages thereof, reference now is made to the following descriptions taken in connection with the accompanying drawings.

FIG. 1 is a block diagram of a first exemplary embodiment of an arrangement according to the present invention for providing information for a process.

FIG. 2 is a block diagram of a second exemplary embodiment of the arrangement according to the present invention for providing information for the process.

FIG. 3. is an exemplary illustration of an exemplary Hypertext Mark-up Language page created by the arrangement of FIG. 1 and/or the arrangement of FIG. 2.

FIG. 4 is a flowchart of a first exemplary embodiment of a method according to the present invention for providing information for the process.

FIG. 5 is a flowchart of a second exemplary embodiment of the method according to the present invention for providing information for the process.

### DETAILED DESCRIPTION

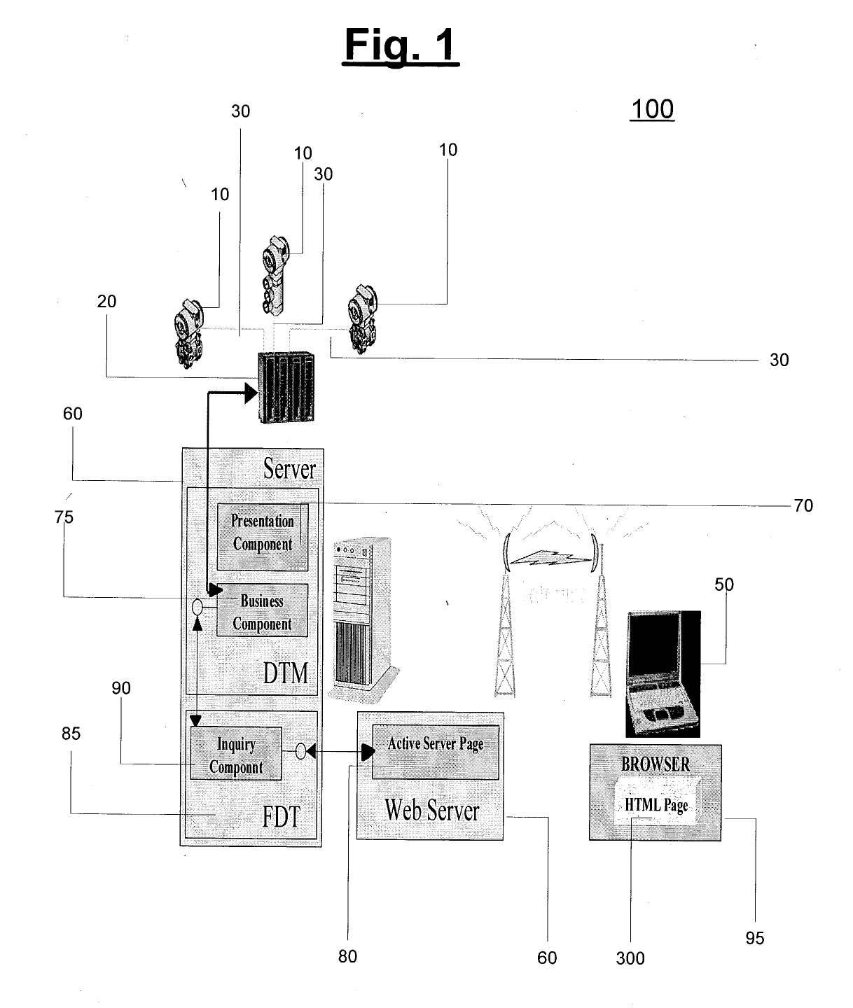

Preferred embodiments of the present invention and their advantages may be understood by referring to FIGS. 1-5, like numerals being used for like corresponding parts in the various drawings.

Referring to FIG. 1, a first exemplary embodiment of an arrangement 100 for providing information for a process according to the present invention is depicted. The arrangement 100 may include one or more field devices 10 (e.g., smart field devices) positioned on a network, and each field device 10 may include a processor (not shown). Each of the field devices 10 may be a sensor, a control element, etc. Such sensors may include temperature sensors, pressure sensors, flow rate sensors, etc., and the control elements may include valves, switches, etc. Moreover, each field device 10 may be adapted to measure instantaneous values of certain parameters of a process or processes which is/are controlled by the arrangement 100 by using function blocks (also not shown). In one exemplary embodiment of the present invention, each field device 10 may be communicatively coupled to at least one other field device 10 using an open smart communications protocol network 30. Such open smart communications protocols may include protocols such as HART®, PROFIBUS®, FOUNDATION® Fieldbus, etc.

The arrangement 100 also may include a controller 20. The controller 20 may include a processor (not shown), and also can be communicatively coupled to each field device 10 using the open smart communications protocol network 30. The arrangement 100 may further have a first processing system 60 (e.g., a first server), and a second processing system 40 (e.g., a second server). The first processing system 60 may be communicatively coupled to the second processing system 40, and the second processing system 40 can be communicatively coupled to the controller 20 (e.g., using an Ethernet connection). As such, the second processing system 40 may be communicatively coupled to each of the field devices 10 via the controller 20. In operation, each of the field devices 10 may collect data associated with the function block of that particular field device 10.

For example, in a case when the field device 10 is a sensor, the data collected by the sensor 10 may include values associated with the temperature, pressure, flow rate, etc. detected by the sensor 10 at various times. When the field device 10 is a control element, the data collected by the central element 10 may include values associated with the position of the control element 10 at various times. The field devices 10 may subsequently forward such data to the controller 20. The controller 20 may collect the data from each of the field devices 10, and can then forward the collected data to the second processing system 40.

Specifically, the second processing system 40 may include a Device Type Manager 65 (“DTM”) associated with one or more of the field devices 10. The DTM 65 may be a software plugin which can be provided by a manufacturer of the field device 10 along with the field device 10. The DTM 65 may include properties (e.g., parameters, options, configurations, diagnosis, maintenance, graphical user dialogs, etc.) associated with one of the field devices 10, or can have properties associated with a specific group of the field devices 10 (e.g., temperature sensors, pressure sensors, etc.). For example, in the case where the field device 10 is a valve, the parameters may include an instantaneous position of the valve 10, a desired position of the valve 10, a difference between the instantaneous position of the valve 10 and the instantaneous position of the valve 10, etc. Further, the operations associated with each of the field devices 10 may be executed by the DTM 65 (e.g., all of the operations may be executed by the DTM 65). The DTM 65 can include a user interface/presentation portion 70 and a business portion 75, and the first processing system 60 may include an active server page script 80. The business portion 75 may include data associated with one or more of the properties of the field device 10 (e.g., instantaneous values of the parameters measured by the field device 10, parameters of the field device 10, etc.), and the user interface portion 70 may adapted to display the data associated with the one or more properties of the field device 10.

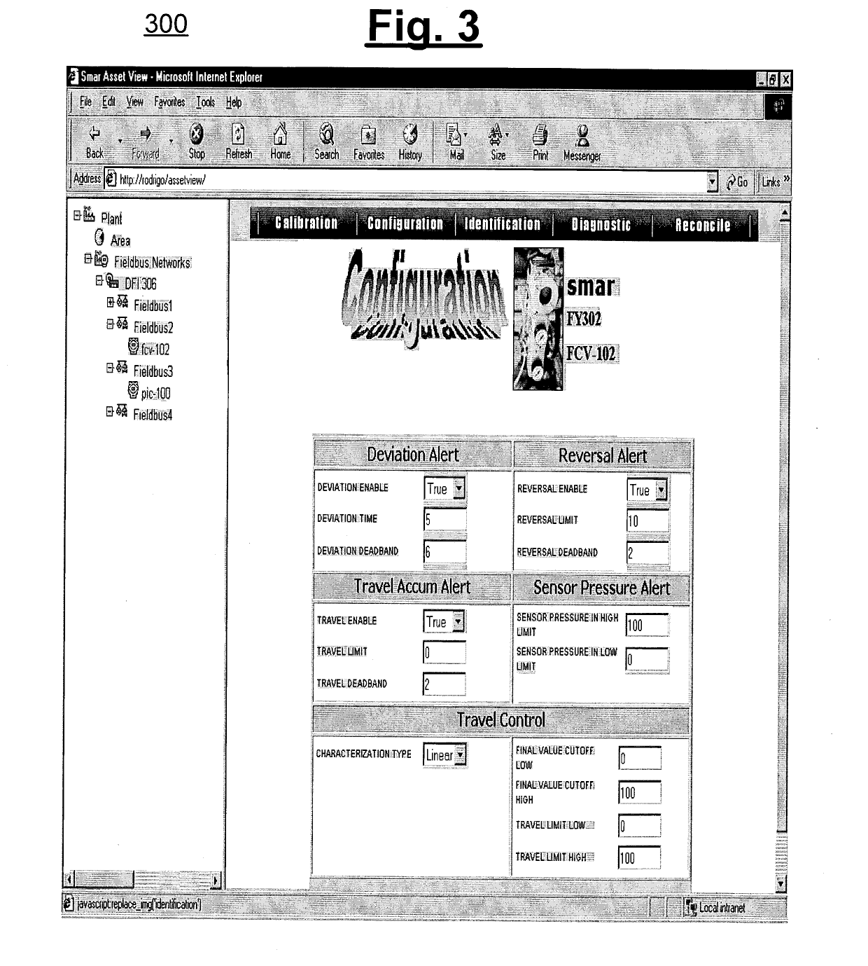

Moreover, the second processing system 40 can include one or more user applications (not shown). For example, the one or more of such user applications can include a Field Device Tool 85 (“FDT”), and the FDT 85 may include an inquiry portion 90. Further, the active server page script 80 may access the inquiry portion 90, and the inquiry portion 90 can be adapted to access the data associated with the one or more properties of the field device 10, and to transmit such data to the first processing system 60 (e.g., by loading the data into a FDT frame). Referring to FIG. 3, when the first processing system 60 receives the data associated with the one or more properties of the field device 10 from the inquiry portion 90 of the first processing system 40, the active server page script 80 may be executed to create an Extensible Mark-up Language page (“XML”) or a Hypertext mark-up Language (“HTML”) page 300, that includes such data (e.g., a Web-type page, a window-type page, a spreadsheet-type page, etc.), and to transmit the XML page or the HTML page 300 to another device.

For example, referring again to FIG. 1, in another exemplary embodiment of the present invention, the arrangement 100 may also include at least one remote processing system 50. The remote processing system 50 may include a browser 95, and can be communicatively coupled to the first processing system 60 (e.g., via wired and/or wireless communications). For example, the remote processing system 50 may be communicatively coupled to the first processing system 60 using an Intranet connection, an Internet connection, etc. The remote processing system 50 may be adapted to (i) forward a request to the first processing system 60 for a receipt of the data associated with the one or more properties of the field device 10, (ii) receive the XML page or the HTML page 300 from the first processing system 60, and (iii) display the XML page or the HTML page 300 to a user (not shown).

Specifically, the user of the remote processing system 50 may utilize the remote processing system 50 to generate a request for the data that is associated with the one or more properties of the field device 10 (e.g., by selecting an icon associated with one or more of the field devices 10), and the remote processing system 50 can forward this request to the first processing system 60. The first processing system 60 (e.g., the active server page script 80 of the first processing system 60) may subsequently access the inquiry portion 90, and the inquiry portion 90 may access the business layer 75 to obtain the data associated with the one or more properties of the field device 10. Moreover, the inquiry portion 90 may transmit the data (associated with such one or more properties of the field device 10) to the first processing system 60, and the first processing system 60 may create the XML page or the HTML page 300. For example, the active server page script 80 of the first processing system 60 may create the XML page or the HTML page 300, and can then transmit the XML page or the HTML page 300 to the remote processing system 50. Further, the remote processing system 50 may display the XML page or the HTML page 300 to the user. In this exemplary embodiment of the present invention, because the code associated with the data is preferably executed by the first processing system 60 (and not by the remote processing system 50), it is not necessary for the remote processing system 50 to download additional software so as to allow the user to view the data. In this manner, the remote processing system 50 is not exposed to any computer executable viruses which may be activated or obtained during such software downloads. Further, the user may access the data using any processing system, e.g., a personal computer, palm pilot, cellular phone, etc., and utilizing any commercially available browser. This is because HTML is an open language, and does not require the use (and thus the download of) any additional software for display of data in the XML format or the HTML format.

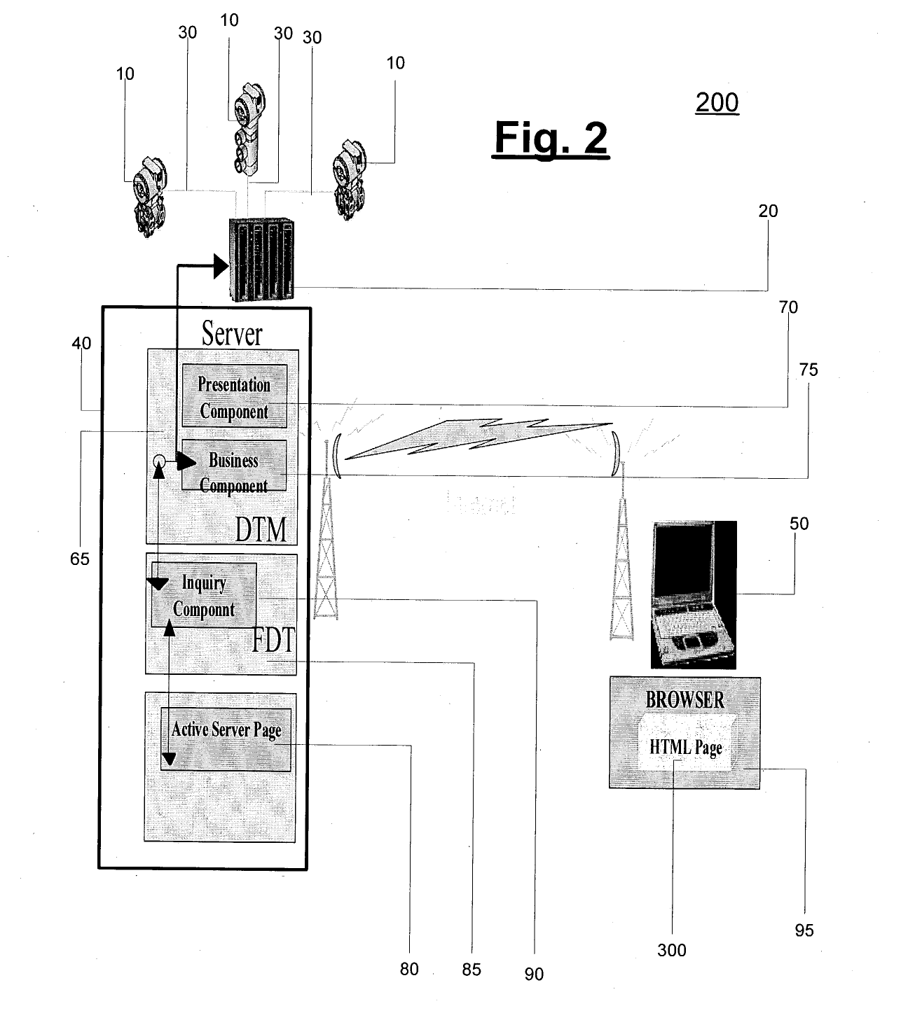

Referring to FIG. 2, a second exemplary embodiment of an arrangement 200 for providing information for a process according to the present invention is depicted. The features and advantages of the first exemplary embodiment of the present invention are substantially similar to the features and advantages of the second exemplary embodiment of the present invention. Therefore, the features and advantages of the first exemplary embodiment of the present invention are not discussed further with respect to the second exemplary embodiment of the present invention.

Additionally, in the second exemplary embodiment of the present invention, the second processing system 40 may be removed, and the first processing system 60 may include the DTM 65, the FDT 85, and the active server page script 80. In operation, the user of the remote processing system 50 may use the remote processing system 50 to generate a request for the data associated with the one or more properties of the field device 10, and the remote processing system 50 can forward this request to the active server page script 80 of the first processing system 60. The active server page script 80 subsequently may access the inquiry portion 90, and the inquiry portion 90 can access the business layer 75 to obtain the data associated with such one or more properties of the field device 10. Moreover, the inquiry portion 90 may transmit the data associated with the properties of the field device 10 to the active server page script 80, and the active server page script 80 may be executed to create the XML page or the HTML page 300. Further, the active server page script 80 may be executed to transmit the XML page or the HTML page 300 to the remote processing system 50, and the remote processing system 50 may display the XML page or the HTML page 300 to the user.

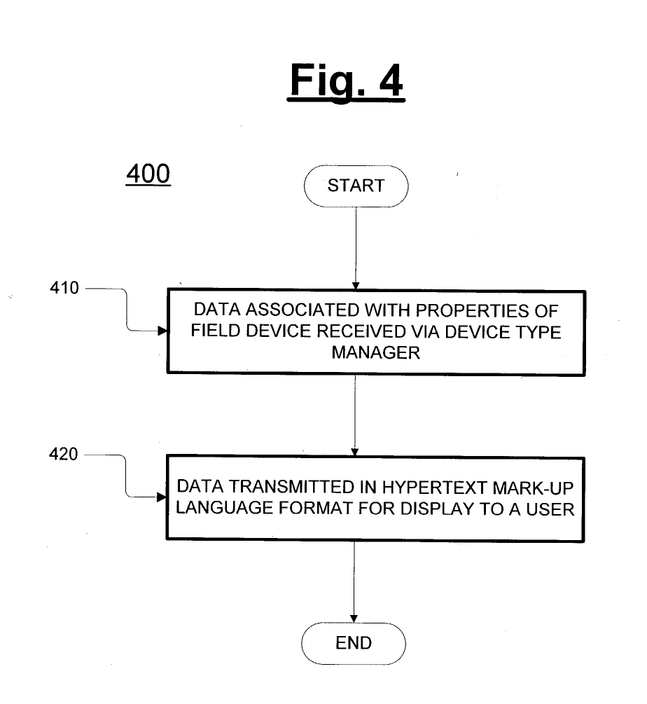

Referring to FIG. 4, a first exemplary embodiment of a method 400 according to the present invention for providing information for a process is depicted. In step 410, the data associated with such one or more properties of the field device 10 is received via the DTM 65. For example, the first processing system 60 and/or the active server page script 80 may be used to receive the data associated with the one or more properties of the field device 10 via the DTM 65. Specifically, the FDT 85 may receive the data associated with such one or more properties of the field device 10 from the DTM 65, and then the first processing system 60 and/or the active server page script 80 may be utilized to receive such data from the FDT 85. Moreover, in step 420, the data associated with the one or more properties of the field device 10 is transmitted in the XML format or the HTML format. For example, the first processing system 60 and/or the active server page script 80 may be used to transmit the data associated with the properties of the field device 10 to the remote processing system 50, and the remote processing system 50 can display the data to the user.

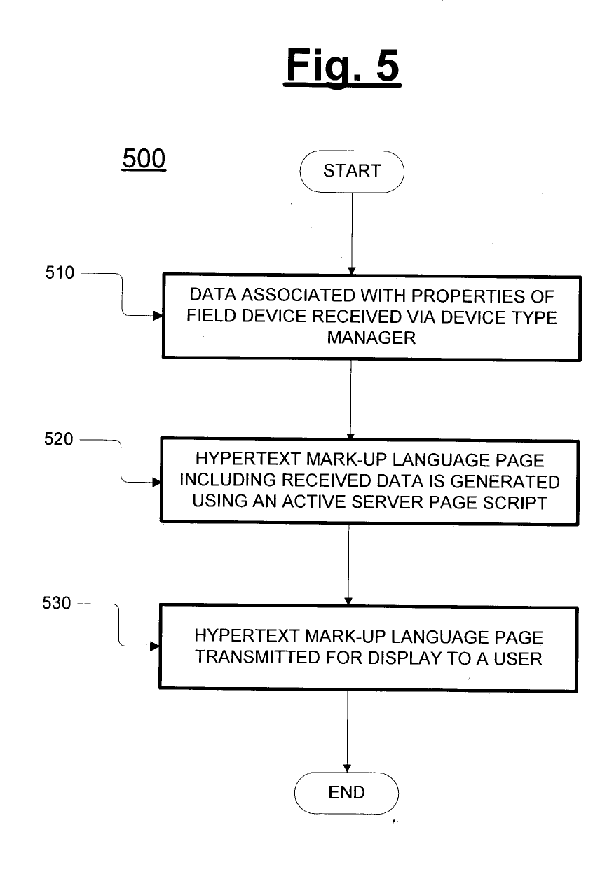

Referring to FIG. 5, a second exemplary embodiment of a method 500 according to the present invention for providing information for a process is depicted. In step 510, the data associated with such one or more properties of the field device 10 is received via the DTM 65. For example, the first processing system 60 and/or the active server page script 80 may be used to receive the data associated with the properties of the field device 10 via the DTM 65. In particular, the FDT 85 may receive the data associated with the properties of the field device 10 from the DTM 65, and then the first processing system 60 and/or the active server page script 80 may receive such data from the FDT 85. In step 520, the XML page or the HTML page 300 including the data associated with the one or more properties of the field device 10 can be created. For example, the first processing system 60 and/or the active server page script 80 may be utilized to create the XML page or the HTML page 300. Moreover, in step 530, the XML page or the HTML page 300 can be transmitted to another device. For example, the first processing system 60 and/or the active server page script 80 may be used to transmit the XML page or the HTML page 300 to the remote processing system 50, and the remote processing system 50 may display the XML page or the HTML page 300 to the user.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. An information arrangement, comprising:
a first processing system communicatively coupled to a second processing system, wherein the second processing system comprises at least one Device Type Manager (“DTM”), and is communicatively coupled to at least one field device, wherein the at least one DTM comprises at least one property associated with the at least one field device, and wherein the first processing system is adapted to receive data associated with the at least one property from the second processing system, and to transmit at least a portion of the data associated with the at least one property in one of an Extensible Mark-up Language (“XML”) format and a Hypertext Mark-up Language (“HTML”) format.

2. The arrangement of claim 1, wherein the first processing system comprises a first server and the second processing system comprises a second server.

3. The arrangement of claim 1, wherein the at least one property comprises at least one of a configuration that is associated with the at least one field device, maintenance information that is associated with the at least one field device, and at least one parameter that is associated with the at least one field device.

4. The arrangement of claim 3, wherein the data associated with the at least one property is at least one of a particular value associated with the at least one parameter and the at least one parameter.

5. The arrangement of claim 4, wherein the particular value is associated with a measurement performed by the at least one field device.

6. The arrangement of claim 5, wherein the measurement performed by the at least one field device is at least one of a temperature measurement, a pressure measurement and a flow-rate measurement.

7. The arrangement of claim 4, wherein the at least one field device comprises a valve, and wherein the at least one parameter is at least one of an instantaneous position of the valve, a desired position of the valve, and a difference between the instantaneous position of the valve and the instantaneous position of the valve.

8. The arrangement of claim 1, wherein the DTM is a software plugin that comprises a user interface portion and a business portion, wherein the business portion comprises the data associated with the at least one property, and wherein the user interface portion is operable to display the data associated with the at least one property.

9. The arrangement of claim 8, wherein the second processing system further comprises at least one user application.

10. The arrangement of claim 9, wherein the at least one user application comprises a Field Device Tool (“FDT”), wherein the FDT comprises an inquiry portion, and wherein the first processing system comprises an active server page script.

11. The arrangement of claim 10, wherein the active server page script is operable to access the inquiry portion, and wherein the inquiry portion is operable to access the data associated with the at least one property from the business portion of the DTM, and to transmit the data associated with the at least one property to the first processing system.

12. The arrangement of claim 11, wherein the first processing system is adapted to receive the data associated with the at least one property from the inquiry portion, and wherein the active server page script is executable to create one of an XML page and a HTML page that comprises at least a portion of the data associated with the at least one property, and to transmit the created page using the Internet.

13. The arrangement of claim 12, wherein the created page is one of a Web-type page, a window-type page and a spreadsheet-type page.

14. The arrangement of claim 1, wherein the second processing system is communicatively coupled to a controller, wherein the controller is communicatively coupled to the at least one field device using an open smart communications protocol, and wherein the second processing system is communicatively coupled to the at least one field device via the controller.

15. The arrangement of claim 14, wherein the open smart communications protocol is at least one of a PROFIBUS® protocol, FOUNDATION® Fieldbus protocol and a HART® protocol.

16. The arrangement of claim 1, wherein the at least one smart field device is at least one of a temperature sensor, a pressure sensor, a flow rate sensor, a valve and a switch.

17. An information arrangement, comprising:
a processing system communicatively coupled to at least one field device, wherein the processing system comprises at least one Device Type Manager (“DTM”), wherein the at least one DTM comprises at least one property associated with the at least one field device, and wherein the processing system is adapted to transmit at least a portion of the data associated with the at least one property in one of an Extensible Mark-up Language format and a Hypertext Mark-up Language format.

18. A method for providing information in a process, comprising the steps of:
receiving data associated with at least one property via at least one Device Type Manager (“DTM”), wherein the at least one property is associated with at least one field device; and
transmitting at least a portion of the data associated with the at least one property in one of an Extensible Mark-up Language (“XML”) format and a Hypertext Mark-up Language (“HTML”) format.

19. The method of claim 18, wherein the at least one property comprises at least one of a configuration associated with the at least one field device, maintenance information associated with the at least one field device, and at least one parameter associated with the at least one field device.

20. The method of claim 19, wherein the data associated with the at least one property is at least one of a particular value that is associated with the at least one parameter and the at least one parameter.

21. The method of claim 20, wherein the particular value is associated with a measurement performed by the at least one field device.

22. The method of claim 21, wherein the measurement performed by the at least one field device is at least one of a temperature measurement, a pressure measurement and a flow-rate measurement.

23. The method of claim 20, wherein the at least one field device comprises a valve, and wherein the at least one parameter is at least one of an instantaneous position of the valve, a desired position of the valve, and a difference between the instantaneous position of the valve and the instantaneous position of the valve.

24. The method of claim 18, wherein the DTM is a software plugin that comprises a user interface portion and a business portion, wherein the business portion comprises the data associated with the at least one property, and wherein the user interface portion is operable to display the data associated with the at least one property.

25. The method of claim 24, wherein the transmitting step comprises the steps of:
creating one of an XML page and a HTML page using an active server page script, wherein the created page comprises at least a portion of the data associated with the at least one property; and
transmitting the created page using the Internet.

26. The method of claim 25, wherein the created page is one of a Web-type page, a window-type page and a spreadsheet-type page.

27. The method of claim 18, wherein the at least one smart field device is at least one of a temperature sensor, a pressure sensor, a flow rate sensor, a valve and a switch.

28. A storage medium comprising executable instructions for providing information in a process, wherein, when the executable instructions are executed by a first processing system, the executable instructions perform the steps comprising of:
receiving data associated with at least one property via at least one Device Type Manager, wherein the at least one property is associated with at least one field device; and
transmitting at least a portion of the data associated with the at least one property in one of an Extensible Mark-up Language format and a Hypertext Mark-up Language (“HTML”) format.
